(19) United States
(12) Patent Application Publication
(10) Pub. No.: US 2016/0020984 A1
(43) Pub. Date: Jan. 21, 2016

(54) INFORMATION PROCESSING APPARATUS, METHOD, AND SYSTEM, AND NON-TRANSITORY COMPUTER READABLE MEDIUM

(71) Applicant: FUJI XEROX CO., LTD., Tokyo (JP)

(72) Inventor: Hiroaki MACHIDA, Kanagawa (JP)

(73) Assignee: FUJI XEROX CO., LTD., Tokyo (JP)

(21) Appl. No.: 14/600,665

(22) Filed: Jan. 20, 2015

(30) Foreign Application Priority Data
Jul. 17, 2014 (JP) 2014-147059

(51) Int. Cl. H04L 12/26; H04L 29/08

(52) U.S. Cl. CPC H04L 43/10; H04L 67/10

(57) ABSTRACT

An information processing apparatus includes a first sender and a second sender. The first sender sends, if a type of status information indicating a status of a device is a predetermined type, the status information to an information storage apparatus, which is different from a center apparatus that manages the device. The second sender sends information indicating that the status information has been sent to the information storage apparatus to the center apparatus.

### CROSS-REFERENCE TO RELATED APPLICATIONS

This application is based on and claims priority under 35 USC 119 from Japanese Patent Application No. 2014-147059 filed Jul. 17, 2014.

### BACKGROUND

1. Technical Field

The present invention relates to an information processing apparatus, method, and system, and a non-transitory computer readable medium.

2. Summary

According to an aspect of the invention, there is provided an information processing apparatus including a first sender and a second sender. The first sender sends, if a type of status information indicating a status of a device is a predetermined type, the status information to an information storage apparatus, which is different from a center apparatus that manages the device. The second sender sends information indicating that the status information has been sent to the information storage apparatus to the center apparatus.

### BRIEF DESCRIPTION OF THE DRAWINGS

Exemplary embodiments of the present invention will be described in detail based on the following figures, wherein:

FIG. 1 is a block diagram illustrating conceptual modules of an example of the configuration of a first exemplary embodiment;

FIG. 2 is a block diagram illustrating an example of the system configuration which implements exemplary embodiments of the invention;

FIG. 3 is a flowchart illustrating an example of processing performed in the first exemplary embodiment;

FIG. 4 illustrates an example of the data structure of a data informing method table;

FIG. 5 is a block diagram illustrating conceptual modules of an example of the configuration of a second exemplary embodiment;

FIG. 6 is a block diagram illustrating conceptual modules of an example of the configuration of a third exemplary embodiment;

FIG. 7 illustrates an example of the data structure of a data informing method table;

FIG. 8 illustrates an example of the data structure of a data informing method table;

FIGS. 9A and 9B illustrate examples of the data structures of a data informing method table and a time-period transfer speed table, respectively;

FIGS. 10A, 10B, and 10C illustrate examples of the data structures of a data informing method table, a time-period transfer speed table, and a special-day time-period transfer speed table, respectively;

FIGS. 11A, 11B, and 11C illustrate examples of the data structures of a data informing method table, a time-period transfer speed table, and a special day (center) table 1160, respectively;

FIG. 12 is a block diagram illustrating conceptual modules of an example of the configuration of a fourth exemplary embodiment;

FIGS. 13A and 13B illustrate examples of the data structures of a data informing method table and an association table indicating the association between the data size and the number of component modules, respectively;

FIG. 14 is a block diagram illustrating conceptual modules of an example of the configuration of a fifth exemplary embodiment;

FIGS. 15A, 15B, and 15C illustrate examples of the data structures of a data informing method table, a time-period transfer speed table, and an assumed communication time table, respectively; and

FIGS. 16 and 17 are block diagrams illustrating examples of the hardware configuration of a computer that implements exemplary embodiments of the invention.

### DETAILED DESCRIPTION

Exemplary embodiments of the present invention will be described below with reference to the accompanying drawings.

### First Exemplary Embodiment

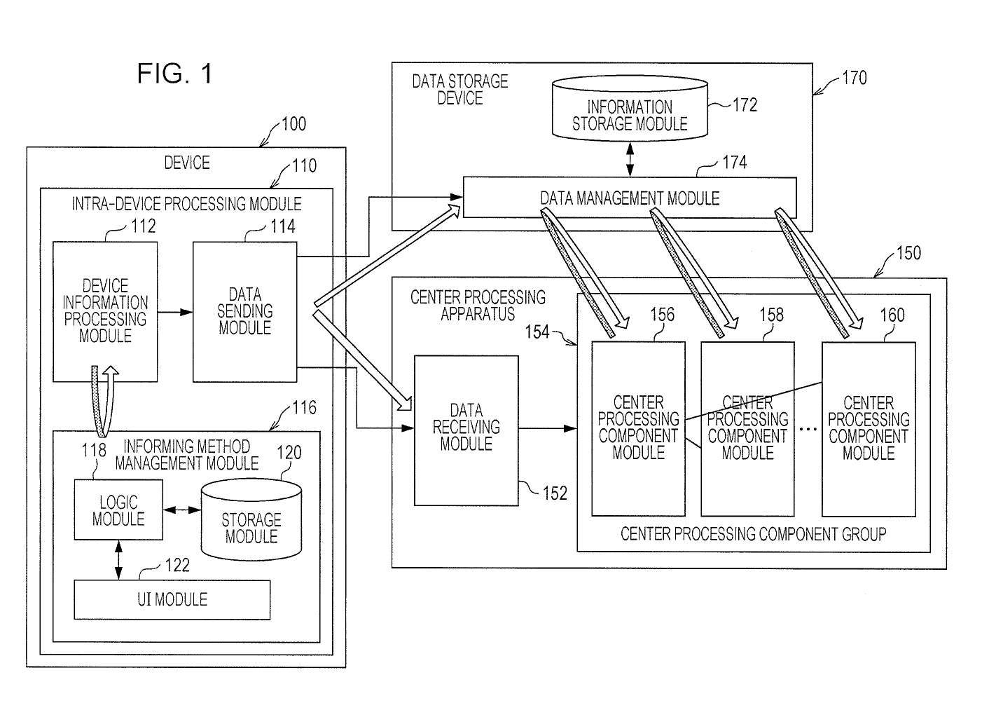

FIG. 1 is a block diagram illustrating conceptual modules of an example of the configuration of a first exemplary embodiment.

Generally, modules are software (computer programs) components or hardware components that can be logically separated from one another. Accordingly, the modules of the exemplary embodiments of the invention are not only modules of a computer program, but also modules of a hardware configuration. Thus, the exemplary embodiments will also be described in the form of a computer program for allowing a computer to function as those modules (a program for causing a computer to execute program steps, a program for allowing a computer to function as corresponding units, a computer program for allowing a computer to implement corresponding functions), a system, and a method. While expressions such as “store”, “storing”, “being stored”, and equivalents thereof are used for the sake of description, such expressions indicate, when the exemplary embodiments relate to a computer program, storing the computer program in a storage device or performing control so that the computer program is stored in a storage device. Modules may correspond to functions based on a one-on-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationship among data elements, etc.). The term “predetermined” means being determined prior to a certain operation, and includes the meaning of being determined prior to a certain operation before starting processing of the exemplary embodiments, and also includes the meaning of being determined prior to a certain operation even after starting processing of the exemplary embodiments, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is necessary.

A system or an apparatus may be realized by connecting plural computers, hardware units, devices, etc., to one another via a communication medium, such as a network (including communication based on a one-on-one correspondence), or may be realized by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processed result is written into the storage device. Accordingly, a description of reading from the storage device before an operation or writing into the storage device after an operation may be omitted. Examples of the storage device may be a hard disk (HD), a random access memory (RAM), an external storage medium, a storage device using a communication line, a register within a central processing unit (CPU), etc.

A system of the first exemplary embodiment includes a device 100, a center processing apparatus 150, and a data storage device 170. In this system, information indicating the status of the device 100 is sent to the center processing apparatus 150. As shown in FIG. 1, the device 100, the center processing apparatus 150, and the data storage device 170 are connected to one another via a communication network.

An example of the services provided by the system of the first exemplary embodiment is remote monitoring services for monitoring the status of the device 100.

A description will now be given of remote monitoring services which are provided between a center processing apparatus and devices and which do not include an informing method management module 116 of the exemplary embodiments of the invention.

The remote monitoring services have originally been started by providing minimal data-sending and maintenance services, and have been expanded as a result of gradually increasing the contents and types of data to be sent and by providing a wide variety of services. In accordance with the expansion of remote monitoring services, a variety of types and sizes of items of data are sent to a center processing apparatus from devices worldwide under various Internet environments. For example, the types of and the size of items of data are being diversified, for example, there are a large size of data and a small size of data. Concerning the Internet environments, in some environments, the speed is constantly high, and in some environments, the speed is constantly low. Even in the same environment, the Internet speed may differ according to the time period. For example, during a lunch break time, the Internet speed may be reduced to one half, one third, or even less of that during normal hours.

Generally, it takes time to send a large size of data. However, even for a small size of data, it may take time to send such data. For example, if the condition of a communication network is poor due to the installation environment of a device, even a small size of data takes time to send from such a device than from a device installed in a normal environment.

That is, variations of factors influencing the communication time to take, such as the type and size of data and the environment of a communication network (including a difference in the environment depending on the time period), are increasing. As a result, the time taken to send data to a center processing apparatus greatly differs depending on these factors.

Even before, if the communication performance is temporarily decreased in a certain time period, sending of data has not been completed within a communication timeout period and is retried until the data is sent, or sending of the data has failed even after a predetermined number of retries. These days, there are more and more differences in the data size and communication time, and thus, it is more difficult to provide the above-described services by sending all types of data in HTTP (HyperText Transfer Protocol) requests and by using the prescribed communication timeout techniques.

More specifically, the following inconsistencies and wastes are becoming obvious, and for securing the stable service quality, it is desirable to address such issues.

(1) If the same transfer timeout period as that for a small size of data is set for a large size of data, timeout is highly likely to occur when sending a large size of data.

(2) If a timeout period suitable for a large size of data is set, a center processing apparatus tries to obtain data sent from a communication network having improper performance by spending a long time while maintaining (occupying) the connection with a device using such a network. In this manner, resources of the center processing apparatus are wasted.

There may be some devices in which timeouts frequently occur. If such devices retry sending data many times, there will be a burden for a center processing apparatus. The failure of communication (data informing loss) leads to a decrease in the quality of services.

Transferring of data between plural components of a center processing apparatus is not always necessary. In particular, for a large size of data, resources of the center processing apparatus are wasted.

An overview of the exemplary embodiments of the invention will be discussed below. This description will be given for facilitating the understanding of the exemplary embodiments.

In accordance with the widespread use of communication networks (in particular, Internet environments), various cloud services have appeared, and environments in which services using the Internet by integrating, not only an on-premises server, but also cloud services are being provided.

In the exemplary embodiments of the invention, data sending from the device 100 to the center processing apparatus 150 is performed by incorporating data storage services provided by clouds into a component of the system of the exemplary embodiments. For example, in the system of the exemplary embodiments, in addition to a method in which the content of data is sent by using simple object access protocol (SOAP), a method in which the content of data per se is stored in the data storage device 170 (for example, a cloud) is integrated.

The method in which the content of data is stored in the data storage device 170 and information that the content of data is stored in the data storage device 170 is sent to the center processing apparatus 150 is different from the method in which data is sent by using SOAP in the following points.

(1) It is not necessary to send a large size of data in the form of HTTP to the center processing apparatus 150. Accordingly, a variation in the data size received by the center processing apparatus 150 is small. Thus, it is possible to prevent the connection with a device from being occupied by sending a large size of data, which would otherwise cause the frequent occurrence of timeouts.

(2) The device 100, which is a sender, performs two operations, such as storing of data in the data storage device 170 and informing the center processing apparatus 150 of the storage of data. Accordingly, communication processing, for example, starting the connection, is required both to connect to the data storage device 170 (when storing data in the data storage device 170) and to the center processing apparatus 150 (when performing SOAP communication).

(3) If plural center processing component modules refer to the content of data stored in the data storage device 170, they individually obtain data from the data storage device 170. Generally, it takes more time to obtain data from the data storage device 170 than to obtain data within the center processing apparatus 150.

(4) Conversely, if the center processing component modules that need to perform data processing are restricted, it is possible to avoid transferring of unnecessary messages in the individual layers of the center processing component modules of the center processing apparatus 150 by storing data in the data storage device 170. This makes it possible to reduce the use of the computational resources, such as a memory, a disk, and processing time, in each center processing component module, for transferring messages.

In the exemplary embodiments of the invention, the two methods having these differences are combined, and one of the methods is selected and the selected method is changed according to the situation.

The device 100 includes an intra-device processing module 110. The device 100 is a machine. Examples of the device 100 are an image processing device such as a copying machine, a fax machine, a scanner, a printer, a multifunction device (image processing device including the functions of at least two of a scanner, a printer, a copying machine, and a fax machine) and an information processing apparatus, such as a personal computer (PC). However, the device 100 may be of any type as long as it has functions unique to the device 100 and a function of sending information indicating the status of the device 100 to the center processing apparatus 150.

The intra-device processing module 110 includes a device information processing module 112, a data sending module 114, and an informing method management module 116. The intra-device processing module 110 has the function of sending information indicating the status of the device 100 to the center processing apparatus 150.

Specific processing of the intra-device processing module 110 will be discussed below. The intra-device processing module 110 selects, for each information type, the method in which data is directly sent to the center processing apparatus 150 by using SOAP or the method in which data is stored in the data storage device 170 and information that data is stored in the data storage device 170 is sent to the center processing apparatus 150. For selecting one of the two methods, the intra-device processing module 110 has a table (for example, a data informing method table 400) used for deciding, for each information type, which of the methods will be used to send information to the center processing apparatus 150. When sending a certain piece of information, the intra-device processing module 110 refers to this table and decides the informing method, and sends data by using the decided informing method. If the table indicates “storing in data storage device”, data itself indicating the status of the device 100 is stored in the data storage device 170, and information concerning the storage location of the data is sent to the center processing apparatus 150.

The device information processing module 112 is connected to the data sending module 114. The device information processing module 112 receives status information indicating the status of the device 100. Then, if the type of status information is a predetermined type which has been determined by the informing method management module 116, the device information processing module 112 sends the status information to the data storage device 170 via the data sending module 114. The data storage device 170 is different from the center processing apparatus 150 (that is, the data storage device 170 is a housing independent of the center processing apparatus 150) and is connected to the center processing apparatus 150 via a communication network. In this case, the above-described predetermined type is a type which has been set in accordance with the size of status information or the need for each of center processing component modules within a center processing component group 154 of the center processing apparatus 150 to obtain the status information. Then, the device information processing module 112 sends, via the data sending module 114, information indicating that the status information has been sent to the data storage device 170 to the center processing apparatus 150, which manages the device 100.

More specifically, the device information processing module 112 creates data to be sent to the center processing apparatus 150 in accordance with the status of the device 100 and instructs the data sending module 114 to send the data. In this case, the device information processing module 112 refers to the data informing method field of the above-described table managed by the informing method management module 116 and sends the data in accordance with the method indicated by the data informing method field.

If the data informing method field indicates “storing in data storage device”, the device information processing module 112 directly sends the status information to the data storage device 170, and informs the center processing apparatus 150 that the status information is stored in the data storage device 170.

If the data informing method field indicates “direct sending (directly storing data in the center processing apparatus 150)”, the device information processing module 112 includes the status information in, for example, HTTP data, and sends it to the center processing apparatus 150 by using, for example, SOAP communication.

As the conditions for selecting the data informing method, the device information processing module 112 may prepare two predetermined thresholds concerning the data size, and may set the following four conditions in accordance with combinations of the size of status information and the need for each of center processing component modules within the center processing component group 154 of the center processing apparatus 150 to obtain the status information.

(1) If the data size is small (if the value of the size of status information is equal to or smaller than a predetermined threshold A), “direct sending” is selected.

(2) If the data size is medium (if the value of the size of status information is equal to or greater than the predetermined threshold A and is equal to or smaller than a predetermined threshold B (the threshold B is greater than the threshold A) and if the number of center processing component modules that process the status information is equal to or more than a predetermined threshold C, “direct sending” is selected.

(3) If the data size of status information is medium and if the number of center processing component modules that process the status information is equal to or less than the predetermined threshold C, “storing in data storage device” is selected.

(4) If the data size is large (if the value of the size of status information is equal to or greater than the predetermined threshold B, “storing in data storage device” is selected.

The data sending module 114 is connected to the device information processing module 112, a data receiving module 152 of the center processing apparatus 150, and a data management module 174 of the data storage device 170. The data sending module 114 sends status information concerning the device 100 to the center processing apparatus 150 or the data storage device 170 in accordance with an instruction from the device information processing module 112. If status information is sent to the data storage device 170, the data sending module 114 sends information indicating that status information has been sent to the data storage device 170 to the center processing apparatus 150, which manages the device 100.

The informing method management module 116 includes a logic module 118 for setting and managing an informing method, a storage module 120 for storing an informing method setting information for each piece of information, and a user interface (UI) module 122 for checking and setting an informing method. The informing method management module 116 sets or stores a data informing method (“direct sending” or “storing in data storage device”) for each type of status information (may also be referred to as “information type”). In the first exemplary embodiment, the data informing method is set by the device 100, and more specifically, by the UI module 122 of the device 100.

The UI module 122 is connected to the logic module 118. The UI module 122 detects an operation performed by a user on a keyboard, a mouse, or a touch panel provided in the device 100, and sets the informing method in accordance with the detected operation. The UI module 120 also displays a current informing method on a display, such as a liquid crystal display.

The logic module 118 is connected to the storage module 120 and the UI module 122. The logic module 118 stores an informing method in the storage module 120 on the basis of an instruction from the UI module 122. The logic module 118 also informs the device information processing module 112 of the informing method stored in the storage module 120 according to the type of information.

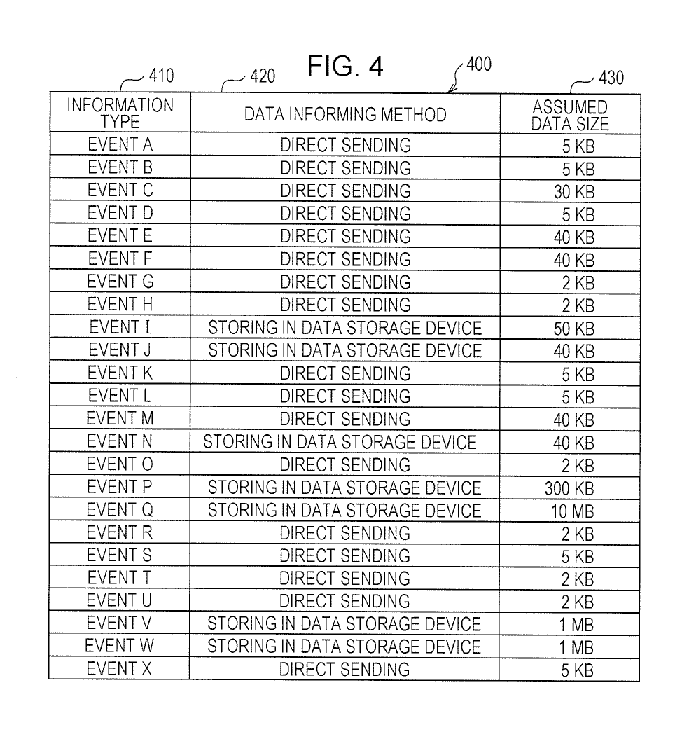

The storage module 120 is connected to the logic module 118. The storage module 120 stores therein, for example, the data informing method table 400 in which conditions are set. FIG. 4 illustrates an example of the data structure of the data informing method table 400. The data informing method table 400 includes an information type field 410, a data informing method field 420, and an assumed data size field 430. The information type field 410 indicates the information type (type of status information). For example, if the device 100 is an image processing device, the information type may be an event indicating the counted number of printed sheets, an event indicating the occurrence of a failure, and an event indicating that the time when consumable components need to be replaced has arrived. The data informing method field 420 indicates a data informing method for each information type. The assumed data size field 430 indicates the assumed data size of each information type. In the example of the data informing method table 400 shown in FIG. 4, the data informing method is set in accordance with the need for each of center processing component modules within the center processing apparatus 150. Alternatively, the data informing method may be set in accordance with the value of the assumed data size of each information type. For example, if the assumed data size of a certain information type is equal to or greater than a predetermined threshold, the data informing method may be set to be “storing in data storage device” (storing in the data storage device 170). In the other cases, the data informing method may be set to be “direct sending” (directly storing in the center processing apparatus 150). The data informing method table 400 may be constituted by the information type field 410 and the data informing method field 420. If the above-described predetermined threshold is used, the data informing method table 400 may be constituted by the information type field 410 and the assumed data size field 430.

The center processing apparatus 150 includes the data receiving module 152 and the center processing component group 154. The center processing apparatus 150 manages the device 100. Specific processing performed by the center processing apparatus 150 is as follows. If the center processing apparatus 150 receives information and if the content of the received information includes data indicating status information, the center processing apparatus 150 processes the data. If the content of the received information does not include data itself concerning status information, but indicates a storage location for the data, the center processing apparatus 150 obtains the data from the storage location and processes it.

The data receiving module 152 is connected to the center processing component group 154 and the data sending module 114 of the device 100. The data receiving module 152 receives status information or information indicating that status information has been sent to the data storage device 170 from the device 100, and transfers data indicating the received information to a certain center processing component module within the center processing component group 154 in accordance with the type of status information.

The center processing component group 154 is connected to the data receiving module 152. In the example shown in FIG. 1, the center processing component group 154 includes center processing component modules 156, 158, and 160. The center processing component group 154 includes at least one center processing component module. The center processing component modules process status information concerning the device 100. For example, a component module performing maintenance-related processing, a component module performing transaction-related processing, and a component module performing logistics-related processing are constructed while relating to one another. In accordance with the type of information, the component modules perform processing if necessary.

Upon receiving information from the device 100, the center processing component modules perform the following processing if it is necessary to perform depending on the content of data.

(1) If received data includes status information, a certain center processing component module conducts a necessary operation (operation logic) by using the data.

(2) If the content of information indicates information that data is stored in the data storage device 170, a certain center processing component module obtains the data from a storage location (data storage device 170) and conducts a necessary operation.

The data storage device 170 includes an information storage module 172 and a data management module 174. The data storage device 170 may be implemented as a data storage service in a cloud.

The information storage module 172 is connected to the data management module 174. The information storage module 172 stores therein status information sent from the device 100 and status information is extracted from the information storage module 172 in response to a request from the center processing apparatus 150.

The data management module 174 is connected to the information storage module 172, the data sending module 114 of the device 100, and center processing component modules, such as the center processing component modules 156, 158, and 160, of the center processing apparatus 150. The data management module 174 receives status information from the device 100 and stores it in the information storage module 172. Then, in response to a request to send status information from a certain center processing component module within the center processing component group 154 of the center processing apparatus 150, the data management module 174 extracts the status information from the information storage module 172 and sends it to this center processing component module.

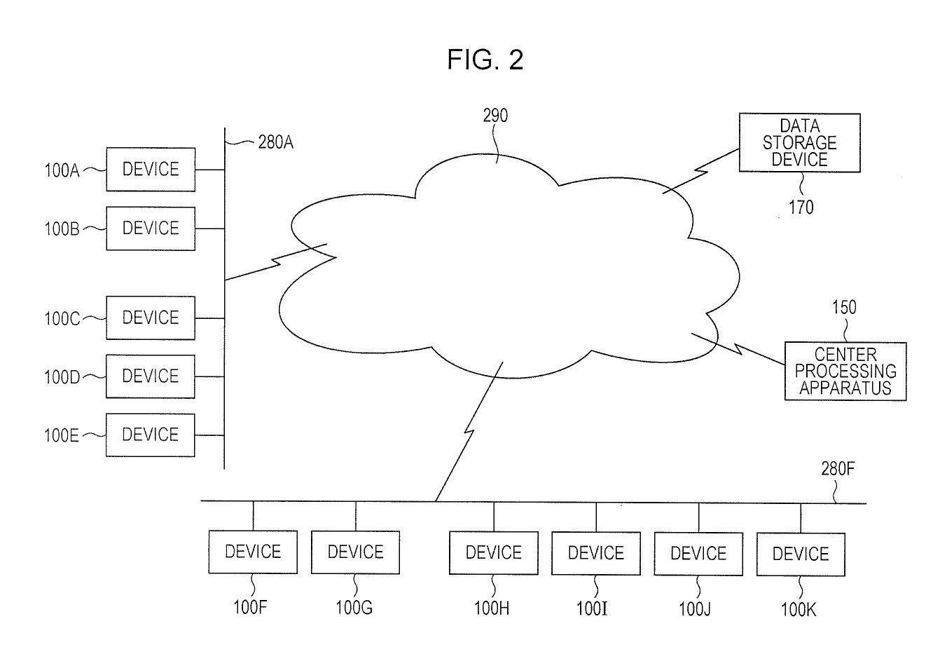

FIG. 2 is a block diagram illustrating an example of the system configuration which implements the exemplary embodiments of the invention.

Devices 100A through 100E are connected to the center processing apparatus 150 and the data storage device 170 via communication networks 280A and 290. Devices 100F through 100K are connected to the center processing apparatus 150 and the data storage device 170 via a communication network 280F and the communication network 290. The communication networks 280A, 280F, and 290 may be a wired or wireless medium or a combination thereof. The communication network 290 may be the Internet as a communication infrastructure. The communication networks 280A and 280F may be an intranet as a communication infrastructure. The data storage device 170 is implemented, for example, as a cloud in the communication network 290.

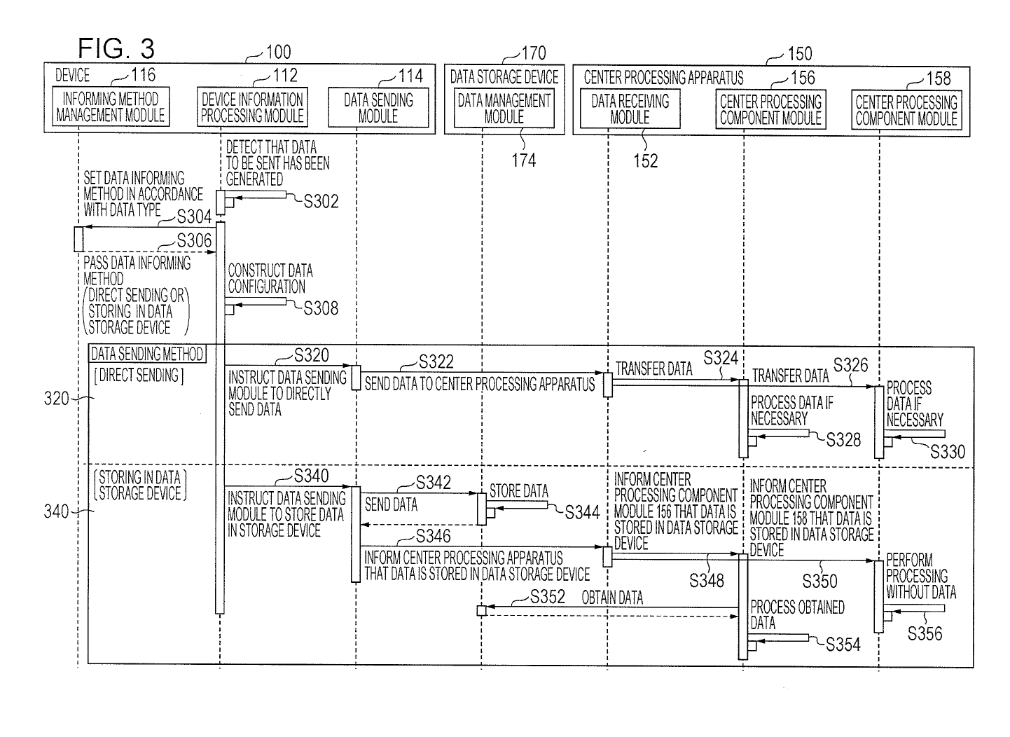

FIG. 3 is a flowchart illustrating an example of processing performed in the first exemplary embodiment.

The processing shown in FIG. 3 is an example of processing performed among the device information processing module 112, the data sending module 114, and the informing method management module 116 of the device 100, the data management module 174 of the data storage device 170, and the data receiving module 152 and the center processing component modules 156 and 158 of the center processing apparatus 150. In this example, the number of center processing component modules within the center processing component group 154 is two, but may be one or three or more.

In step S302, the device information processing module 112 detects that data to be sent has been generated.

In step S304, the device information processing module 112 informs the informing method management module 116 of the information type of data, and the informing method management module 116 sets the data informing method in accordance with the information type of data.

In step S306, the informing method management module 116 informs the device information processing module 112 of the informing method (“direct sending” or “storing in data storage device”).

In step S308, the device information processing module 112 constructs the configuration of data.

Then, in accordance with the informing method set in step S306, one of direct sending processing 320 (steps S320 through S330) and storage processing 340 for storing data in the data storage device 170 (steps S340 through S356) is executed.

In step 5320, the device information processing module 112 instructs the data sending module 114 to directly send data to the center processing apparatus 150.

Then, in step S322, the data sending module 114 directly sends the data to the data receiving module 152 of the center processing apparatus 150.

In step S324, the data receiving module 152 assigns portions of data received from the data sending module 114 to the center processing component modules 156 and 158, and transfers a portion of the data assigned to the center processing component module 156 to the center processing component module 156.

In step S326, the data receiving module 152 transfers a portion of the data assigned to the center processing component module 158 to the center processing component module 158.

In step S328, the center processing component module 156 processes the received portion of data if necessary.

In step S330, the center processing component module 158 processes the received portion of data if necessary.

On the other hand, in step S340, the device information processing module 112 instructs the data sending module 114 to store the data in the data storage device 170.

In step S342, the data sending module 114 sends the data to the data management module 174 of the data storage device 170.

In step S344, the data management module 174 stores the received data in the information storage module 172. The data management module 174 then informs the data sending module 114 that the reception of data has been completed.

In step S346, the data sending module 114 informs the data receiving module 152 of the center processing apparatus 150 that the data is stored in the data storage device 170.

In step S348, the data receiving module 152 informs the center processing component module 156 that the data is stored in the data storage device 170.

In step S350, the data receiving module 152 informs the center processing component module 158 that the data is stored in the data storage device 170.

In step S352, the center processing component module 156 obtains the data from the data management module 174 of the data storage device 170.

In step S354, the center processing component module 156 processes the obtained data.

In step S356, the center processing component module 158 performs processing. Even if data is not necessary, if there is any processing to be executed, the center processing component module 158 performs such processing.

### Second Exemplary Embodiment

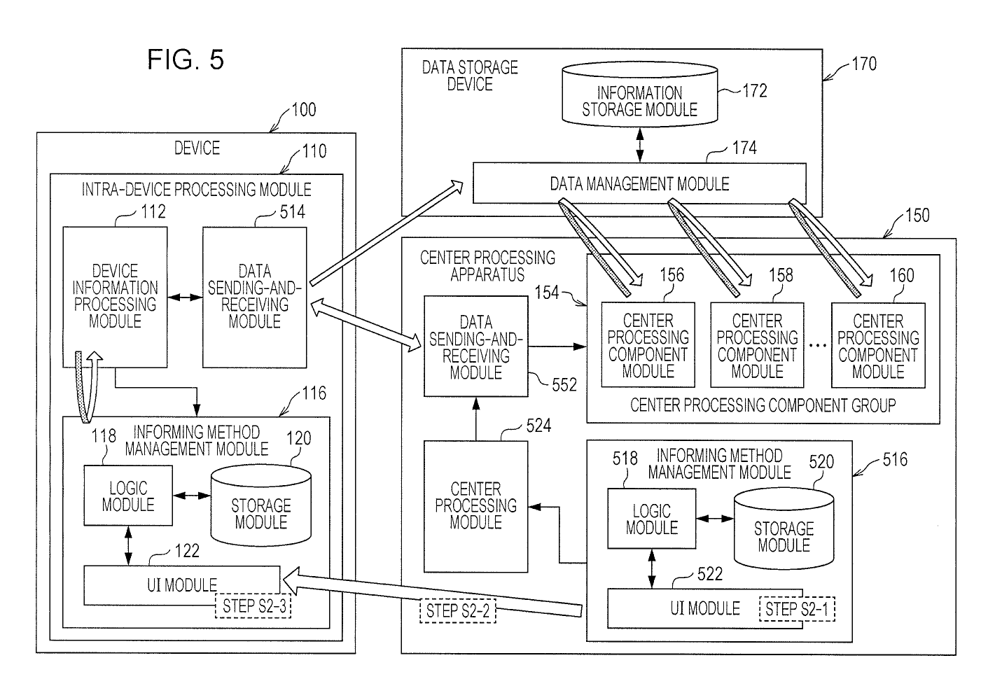

FIG. 5 is a block diagram illustrating conceptual modules of an example of the configuration of a second exemplary embodiment. Elements identical to or similar to those of the first exemplary embodiment are designated by like reference numerals, and an explanation thereof will thus be omitted. Third through fifth exemplary embodiments are treated in a similar manner.

In the second exemplary embodiment, the data informing method set for each type of status information and stored in the device 100 in the first exemplary embodiment can be set by the center processing apparatus 150. The center processing apparatus 150 stores therein information concerning the data informing method set for each type of status information. The data informing method may be changed, and if there is any change made to the data informing method, the center processing apparatus 150 informs each device 100 of this change. The device 100 then reflects this change in the data informing method table 400 stored in the device 100.

For example, it is assumed that the data informing method is initially set to be “storing in data storage device” at the start of the operations of remote monitoring services provided by the center processing apparatus 150, and then, after the actual operations have been started, the data informing method may be changed to “direct sending”, and vice versa. The data informing method tables 400 created at various times and stored in the devices 100 may be updated by the latest setting of the center processing apparatus 150.

More specifically, it is assumed that the data informing method for a certain piece of status information is initially set to be “storing in data storage device” since there are less center processing component modules that refer to this status information and execute operation logic. However, due to a change of the operations, more center processing component modules need this status information, and thus, the data informing method is changed to “direct sending”. As a result, the center processing apparatus 150 directly receives the status information from the device 100 instead of the center processing component modules obtaining the status information from the data storage device 170. In this manner, if the center processing apparatus 150 has changed the data informing method because of some reasons, it informs the device 100 of this change.

In the second exemplary embodiment, in addition to the operations executed in the first exemplary embodiment, the following operations are executed.

In step S2-1, a UI module 522 for checking and setting an informing method of the center processing apparatus 150 changes the data informing method set for a certain type of status information.

In step S2-2, an informing method management module 516 of the center processing apparatus 150 instructs the informing method management module 116 of the device 100 to reflect a change made by the UI module 522 in the data informing method table 400.

In step S2-3, the UI module 122 of the device 100 updates the data informing method table 400 in response to this instruction.

The intra-device processing module 110 includes a device information processing module 112, a data sending-and-receiving module 514, and an informing method management module 116.

The data sending-and-receiving module 514 is connected to the device information processing module 112, a data sending-and-receiving module 552 of the center processing apparatus 150, and a data management module 174 of the data storage device 170. In addition to the processing performed by the data sending module 114 of the first exemplary embodiment, the data sending-and-receiving module 514 sends and receives data to and from the center processing apparatus 150 and the data storage device 170.

The device information processing module 112 is connected to the data sending-and-receiving module 514 and the informing method management module 116. The device information processing module 112 sets a type specified by the center processing apparatus 150 as a predetermined type and performs certain processing. That is, if the type of status information is a type set by the center processing apparatus 150, the device information processing module 112 sends this status information to the data storage device 170, which is different from the center processing apparatus 150. More specifically, if the device information processing module 112 receives an instruction to change the content of the data informing method table 400 from the center processing apparatus 150, it updates the data informing method table 400 stored in the storage module 120 by using the logic module 118. Then, the data sending-and-receiving module 514 sends data in accordance with the updated data informing method table 400.

The center processing apparatus 150 includes a data sending-and-receiving module 552, a center processing component group 154, an informing method management module 516, and a center processing module 524.

The informing method management module 516 includes a logic module 518 for setting and managing an informing method, a storage module 520 for storing an informing method setting information for each piece of information, and a UI module 522 for checking and setting an informing method. The informing method management module 516 is connected to the center processing module 524. The informing method management module 516 performs processing equivalent to the processing performed by the informing method management module 116 of the first exemplary embodiment. The informing method management module 516 also sends the device 100 an instruction to set, as a predetermined type, a type of status information which is set in accordance with the size of status information data or the need for each center processing component module within the center processing apparatus 150 to obtain this status information.

The logic module 518 is connected to the storage module 520 and the UI module 522. The logic module 518 performs processing equivalent to the processing performed by the logic module 118 of the first exemplary embodiment.

The storage module 520 is connected to the logic module 518. The storage module 520 performs processing equivalent to the processing performed by the storage module 120 of the first exemplary embodiment.

The UI module 522 is connected to the logic module 518. The UI module 522 performs processing equivalent to the processing performed by the UI module 122 of the first exemplary embodiment.

The center processing module 524 is connected to the informing method management module 516 and the data sending-and-receiving module 552. The center processing module 524 sends, via the data sending-and-receiving module 552, information changed by the informing method management module 516 to a device 100 which requires this changed information. Generally, a firewall is set in the device 100 and it is not possible to make direct access from an external device, such as the center processing apparatus 150. Accordingly, an instruction for a certain device 100 to change the data informing method is stored in the center processing apparatus 150, and in response to polling communication from this device 100 (access from the device 100 to the center processing apparatus 150 to ask whether or not there is an instruction for the device 100), the center processing module 524 sends this instruction to the device 100 as a response, and causes the device 100 to change the data informing method.

The data sending-and-receiving module 552 is connected to the center processing component group 154, the center processing module 524, and the data sending-and-receiving module 514 of the device 100. In addition to the processing performed by the data receiving module 152 of the first exemplary embodiment, the data sending-and-receiving module 552 sends and receives data to and from the device 100.

### Third Exemplary Embodiment

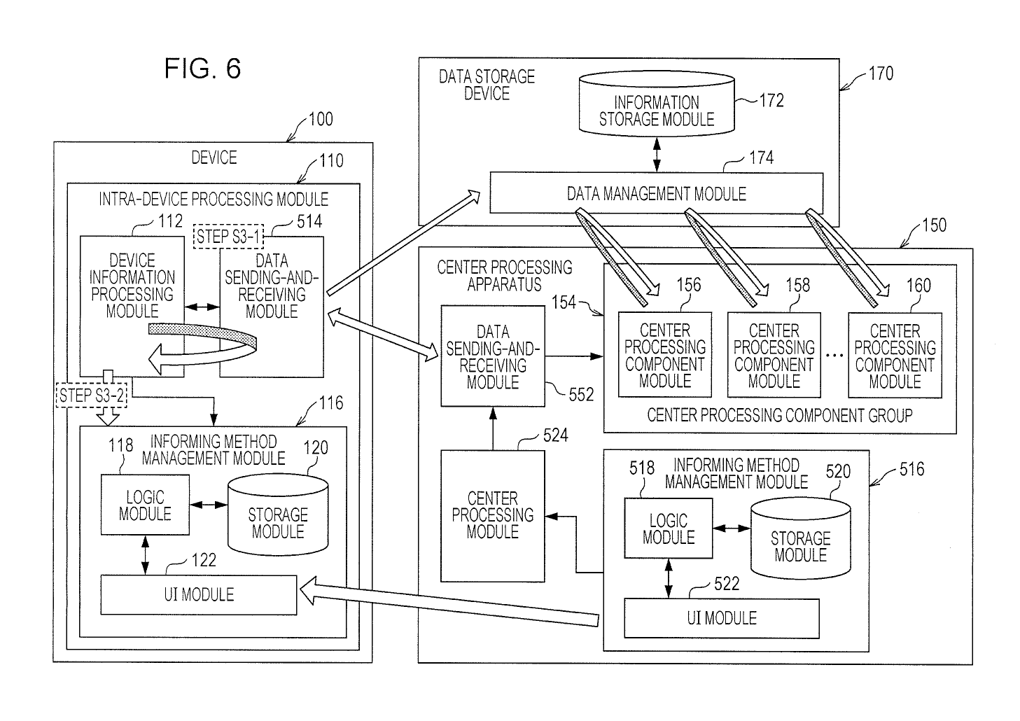

FIG. 6 is a block diagram illustrating conceptual modules of an example of the configuration of a third exemplary embodiment. In the third exemplary embodiment, the device 100 dynamically changes the data informing method in accordance with the communication environment.

As in the first and second exemplary embodiments, the device 100 has default informing methods for each type of status information. However, such informing methods are merely defaults (initial settings).

The device 100 performs the following processing.

(1) The device 100 detects the performance of sending data (status information) by using SOAP.

(2) It is assumed that the data informing method for data (status information) to be now sent is set to be “direct sending”. In this case, if the data has not been successfully sent within a predetermined time period, the data informing method is switched to “storing in data storage device”, and the data is re-sent.

(3) Then, the data informing method in a data informing method table is updated. In this case, if the data informing method is switched to “storing in data storage device” when sending a certain type of information, the other information types in which the data informing method is set as “direct sending” are compared with this information type in terms of the data size. Then, the information types having a data size equal to or greater than the data size of this information type are selected, and then, the data informing method of the selected information types is switched from default “direct sending” to “storing in data storage device”.

(4) If data concerning a certain information type for which the default “direct sending” has been switched to “storing in data storage device” due to a performance reason has been successfully sent by using “direct sending”, the communication performance is checked again. If the communication performance is high enough to perform “direct sending” (using certain decision criteria, for example, the speed is XX bps or higher, or the time taken to send data of an assumed data size is within XX seconds), the informing method of this information type is returned to the default “direct sending”.

In this manner, the device 100 selects the data informing method in accordance with the communication environment in which the device 100 is installed.

In the third exemplary embodiment, the following operations are performed, in addition to the operations of the second exemplary embodiment.

In step S3-1, the device information processing module 112 obtains communication performance information from the data sending-and-receiving module 514.

In step S3-2, the device information processing module 112 determines, from the communication performance information, whether or not to change the data informing method set in the storage module 120 of the informing method management module 116, and changes the data informing method if appropriate.

Then, the data sending-and-receiving module 514 detects the performance in sending status information to the center processing apparatus 150.

The device information processing module 112 compares the value indicating the performance detected by the data sending-and-receiving module 514 with a predetermined threshold, and, if appropriate, it changes the data informing method for the status information from “direct sending” to “storing in data storage device” in accordance with the comparison result.

When sending second status information having a size equal to or greater than that of the status information, the device information processing module 112 changes the data informing method for the second status information from “direct sending” to “storing in data storage device”.

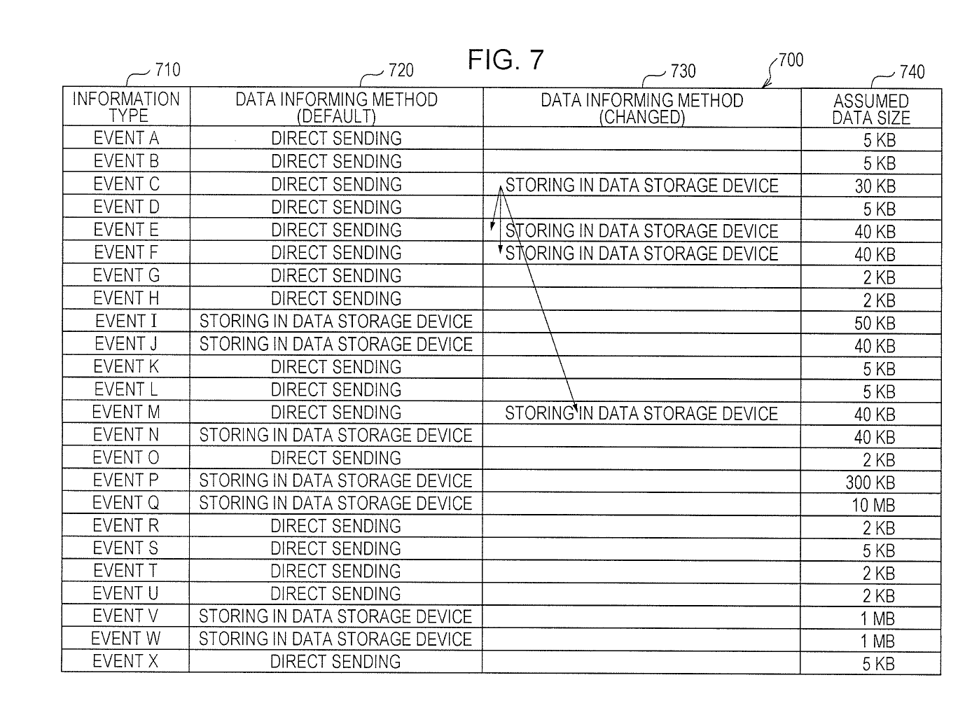

The storage module 120 stores therein, for example, a data informing method table 700. FIG. 7 illustrates an example of the data structure of the data informing method table 700. The data informing method table 700 includes an information type field 710, a data informing method (default) field 720, a data informing method (changed) field 730, and an assumed data size field 740. The information type field 710 indicates the information type (type of status information). The data informing method (default) field 720 indicates a data informing method (default) for each information type. The data informing method (changed) field 730 indicates a current data informing method (changed) for certain information types. If a data informing method is set both in the data informing method (default) field 720 and in the data informing method (changed) field 730, the data informing method set in the data informing method (changed) field 730 is selected. The assumed data size field 740 indicates the assumed data size of each information type. The data informing method table 700 is a table to which the data informing method (changed) field 730 is added to the data informing method table 400 shown in FIG. 4.

For example, FIG. 7 shows that it has taken too much time (time equal to or longer than a predetermined time) to send information concerning an event C, and thus, the default “direct sending” has been changed to “storing in data storage device” for sending this information.

In this case, information types (in the example shown in FIG. 7, event E, event F, and event M) for which the data informing method (default) field 720 indicates “direct informing” and the assumed data size in the assumed data size field 740 is equal to or greater than 30 KB (assumed data size of the event C) are selected. Then, the informing method for the selected information types is switched to “storing in data storage device”.

In the third exemplary embodiment, the device 100 may dynamically change the data informing method in accordance with the communication environment depending on the time period.

In this case, the device information processing module 112 determines whether or not the performance detected by the data sending-and-receiving module 514 matches predetermined conditions. For example, as a result of comparing the performance with a predetermined threshold in a certain time period, the device information processing module 112 may change the data informing method from “direct sending” to “storing in data storage device”.

The device 100 selects the data informing method in accordance with the transfer speed which varies depending on the time period in a communication environment in which the device 100 is installed.

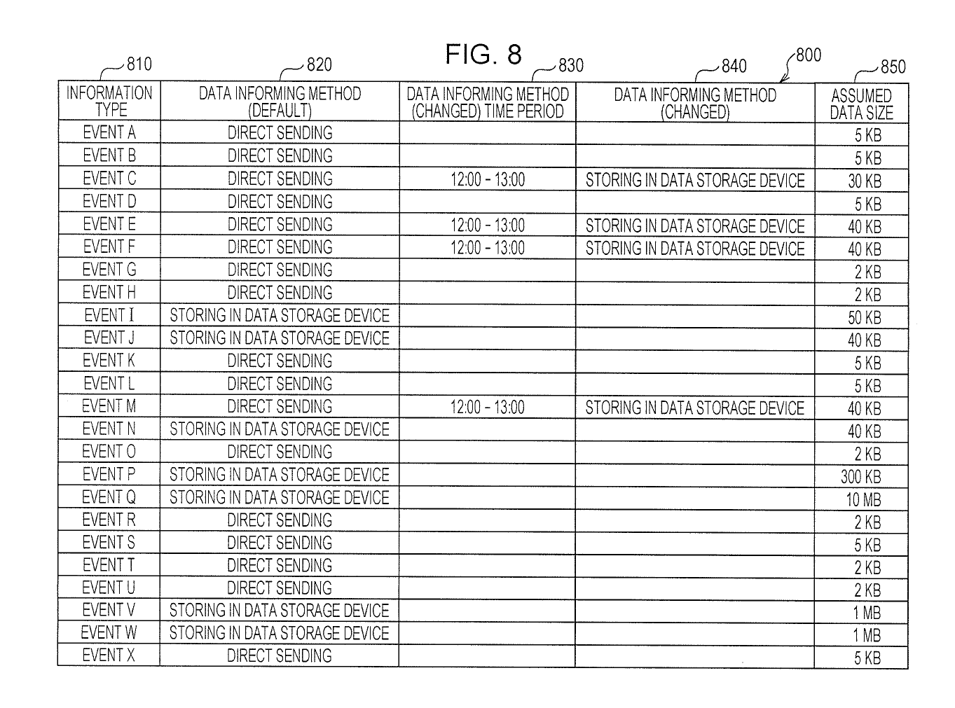

More specifically, the device 100 performs processing as in the following examples (1) through (4) (FIGS. 8 through 11C).

(1) The device 100 detects the communication environment according to the time period, and uses a data informing method table indicating the data informing method according to the time period. For example, the device 100 stores a data informing method table 800 in the storage module 120.

Upon detecting that data to be sent has been generated, the device information processing module 112 selects the informing method according to the current time period stored in the data informing method table 800.

FIG. 8 illustrates an example of the data structure of the data informing method table 800. The data informing method table 800 is a table to which a data informing method (changed) time period field 830 is added to the data informing method table 700 shown in FIG. 7. The data informing method table 800 includes an information type field 810, a data informing method (default) field 820, a data informing method (changed) time period field 830, a data informing method (changed) field 840, and an assumed data size field 850. The information type field 810 indicates the information type (type of status information). The data informing method (default) field 820 indicates a data informing method (default) for each information type. The data informing method (changed) time period field 830 indicates a data informing method (changed) time period for certain information types. The data informing method (changed) field 840 indicates a current data informing method (changed) for certain information types. If the time period is set in the data informing method (changed) time period field 830, the data informing method set in the data informing method (changed) field 840 is selected instead of the data informing method set in the data informing method (default) field 820. If the time period is not set in the data informing method (changed) time period field 830, the data informing method set in the data informing method (default) field 820 is selected. The assumed data size field 850 indicates the assumed data size of each information type.

(2) The device information processing module 112 of the device 100 manages the measured speed depending on time period, and when data to be sent is generated, the device information processing module 112 determines, from the assumed speed of a current time period and the size of this data whether or not the informing method “storing in data storage device” is more suitable than the default “direct sending”, and then supplies the determination result. The device 100 stores, for example, a data informing method table 900 and a time-period transfer speed table 930, in the storage module 120.

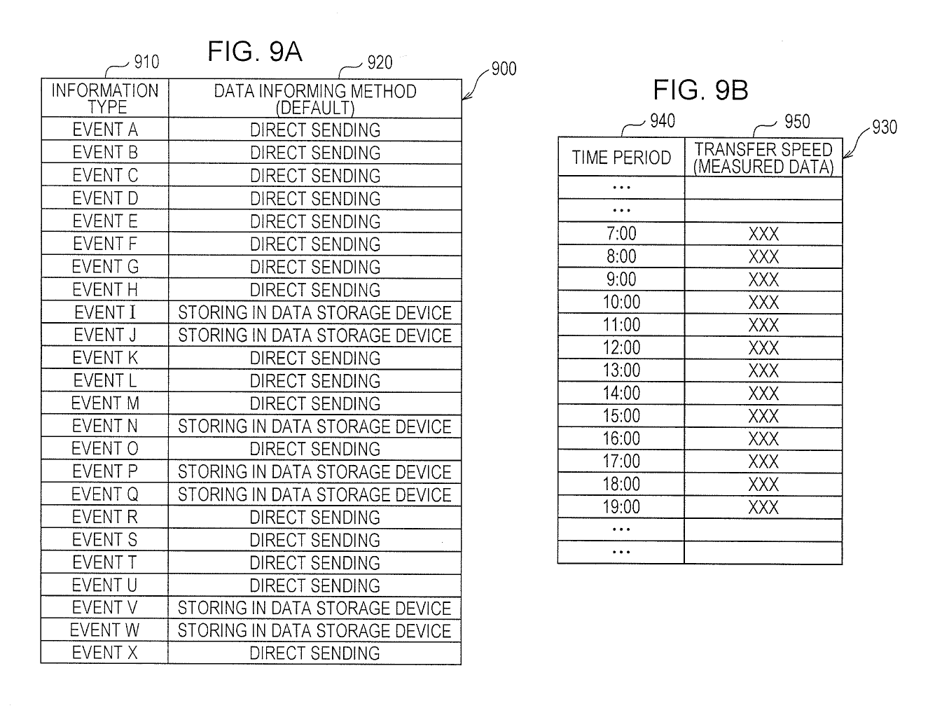

FIGS. 9A and 9B illustrate examples of the data structures of the data informing method table 900 and the time-period transfer speed table 930, respectively. The data informing method table 900 shown in FIG. 9A includes an information type field 910 and a data informing method (default) field 920. The information type field 910 indicates the information type (type of status information). The data informing method (default) field 920 indicates a data informing method (default) for each information type. The time-period transfer speed table 930 shown in FIG. 9B includes a time period field 940 and a transfer speed (measured data) field 950. The time period field 940 indicates the time period. The transfer speed (measured data) field 950 indicates the transfer speed (measured data) according to the time period.

Upon detecting that data to be sent has been generated, the time (XX seconds) to directly send the generated data to the center processing apparatus 150 during a current time period is calculated from the time-period transfer speed table 930. If the calculated time is equal to or more than a predetermined time (XXX seconds), the informing method is switched from the default “direct sending” to “storing in data storage device”.

(3) By considering a case in which the communication environment differs depending on the day (for example, the communication speed becomes slow on a special day since another service utilizes a network on that day), the device 100 registers special days and their assumed speeds. The device 100 stores, for example, the data informing method table 900, the time-period transfer speed table 930, and a special-day time-period transfer speed table 1060, in the storage module 120.

The device information processing module 112 of the device 100 first checks whether or not today is a special day, and if it is, the device information processing module 112 calculates the time taken to directly send data to the center processing apparatus 150 at the assumed speed of that day, and determines whether or not “storing in data storage device” is more suitable than “direct sending”.

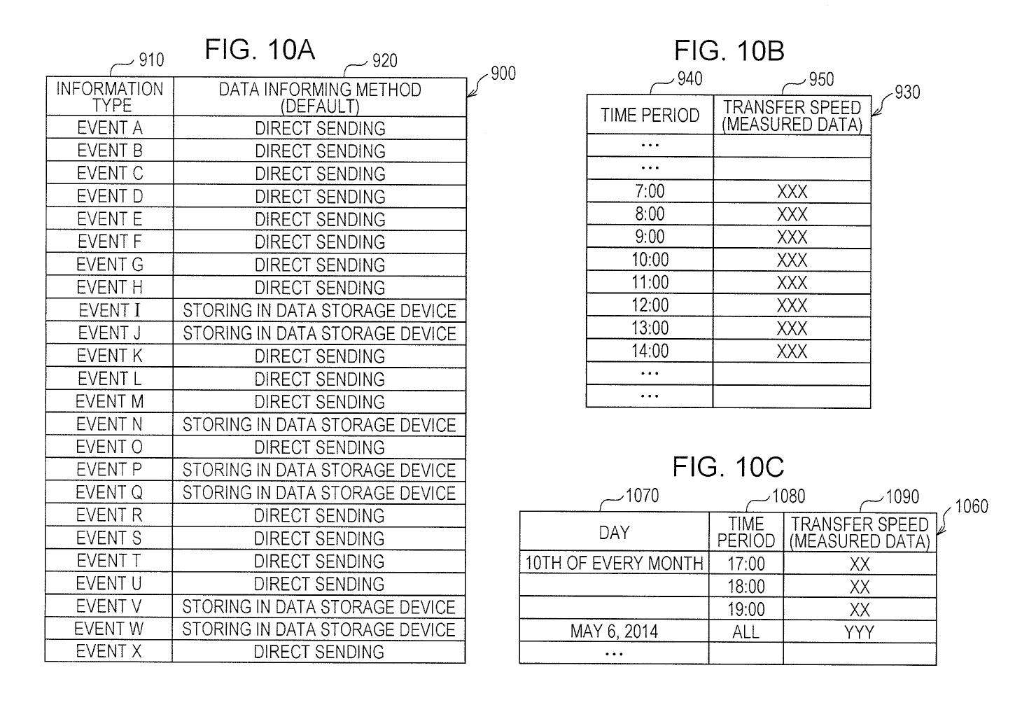

FIGS. 10A, 10B, and 10C illustrate examples of the data structures of the data informing method table 900, the time-period transfer speed table 930, and the special-day time-period transfer speed table 1060, respectively. The data informing method table 900 and the time-period transfer speed table 930 shown in FIGS. 10A and 10B are similar to those shown in FIGS. 9A and 9B, respectively. The special-day time-period transfer speed table 1060 shown in FIG. 10C includes a day field 1070, a time period field 1080, and a transfer speed (measured data) field 1090. The day field 1070 indicates special days. The time period field 1080 indicates time periods of the special days. The transfer speed (measured data) field 1090 indicates the transfer speed (measured data) in each time period of each special day.

Upon detecting that data to be sent has been generated, the time (XX seconds) to directly send the generated data to the center processing apparatus 150 during a current time period is calculated from the time-period transfer speed table 930. It is then checked whether or not today is a special day by using the special-day time-period transfer speed table 1060 (or whether or not a current time is a time period of a special day), and if it is, the time to directly send the generated data to the center processing apparatus 150 is calculated by preferentially using the special-day time-period transfer speed table 1060. If the calculated time is equal to or more than a predetermined time (XXX seconds), the informing method is switched from the default “direct sending” to “storing in data storage device”.

(4) The center processing apparatus 150 is able to set a special day (specified day) in the device 100 depending on a situation, such as the maintenance, of the center processing apparatus 150. The center processing apparatus 150 stores, for example, a special day (center) table 1160, in the storage module 520. Then, if a special day (center) table 1160 is newly created or updated, the center processing apparatus 150 sends the special day (center) table 1160 to the devices 100 managed by the center processing apparatus 150. Then, the special day (center) table 1160 is reflected in each device 100. As a result, the data informing method table 900, the time-period transfer speed table 930, and the special day (center) table 1160 are stored in the storage module 120 of the device 100.

The device 100 inputs a special day set by the center processing apparatus 150 in the special day (center) table 1160. The device information processing module 112 of the device 100 sets the data informing method for such a day (or a certain time period of such a day) to be “storing in data storage device”.

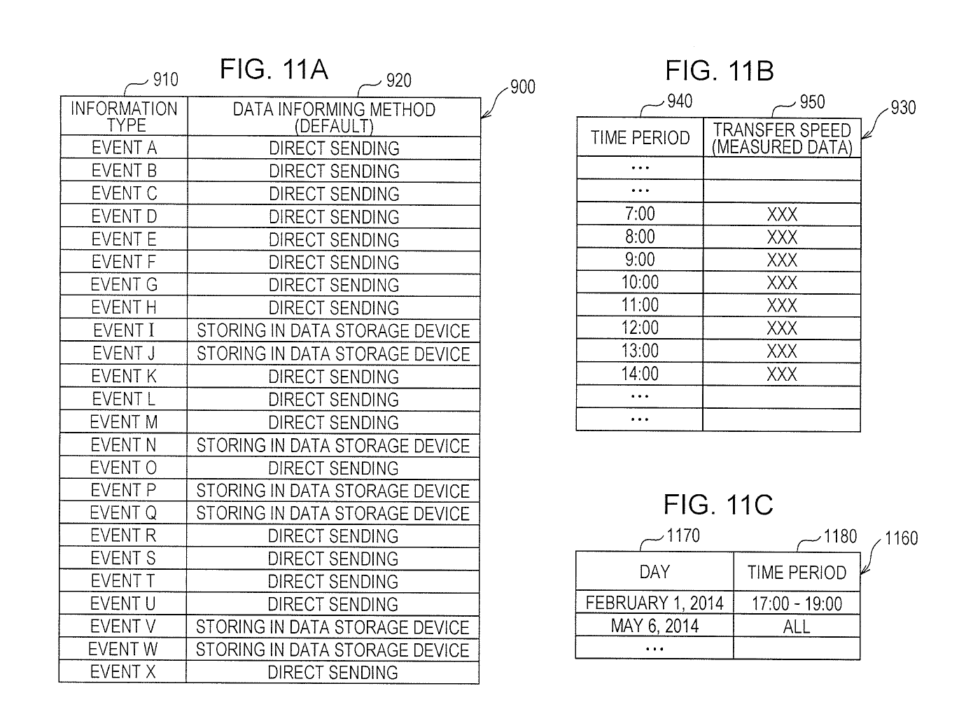

FIGS. 11A, 11B, and 11C illustrate examples of the data structures of the data informing method table 900, the time-period transfer speed table 930, and the special day (center) table 1160, respectively. The data informing method table 900 and the time-period transfer speed table 930 shown in FIGS. 11A and 11B are similar to those shown in FIGS. 9A and 9B, respectively. The special day (center) table 1160 shown in FIG. 11C includes a day field 1170 and a time period field 1180. The day field 1170 indicates a special day in the center processing apparatus 150. The time period field 1180 indicates a time period of a special day (special time period in the center processing apparatus 150).

Upon detecting that data to be sent has been generated, the time (XX seconds) to directly send the generated data to the center processing apparatus 150 during a current time period is calculated from the time-period transfer speed table 930. It is then checked whether or not today is a special day in the center processing apparatus 150 by using the day field 1170 of the special day (center) table 1160 (or whether or not a current time is a specified time period of a special day in the center processing apparatus 150 by using the day field 1170 and the time period field 1180 of the special day (center) table 1160), and if it is, the informing method is switched from the default “direct sending” to “storing in data storage device”.

### Fourth Exemplary Embodiment

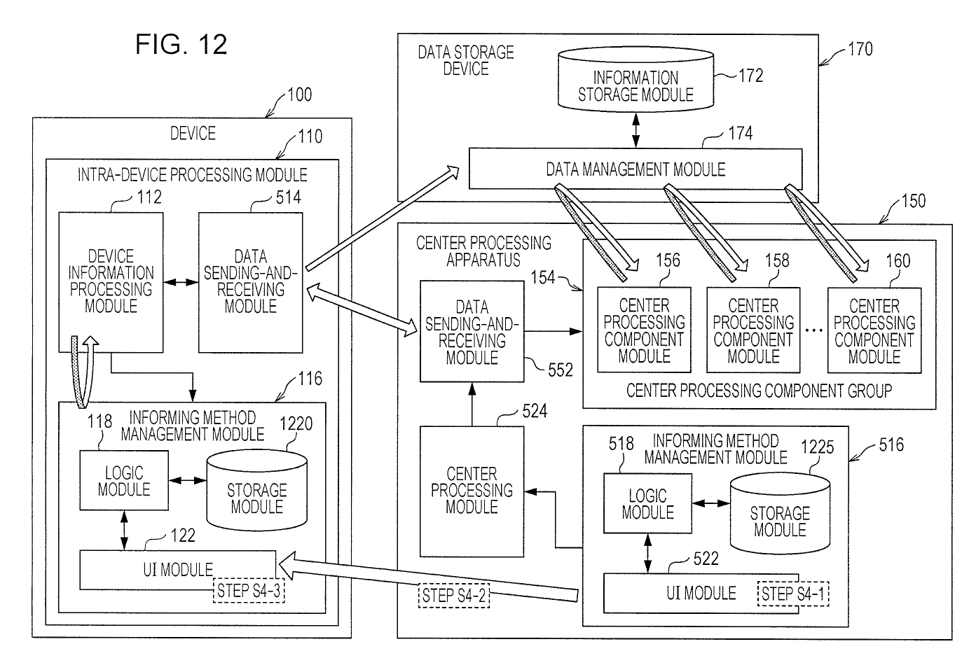

FIG. 12 is a block diagram illustrating conceptual modules of an example of the configuration of a fourth exemplary embodiment. In the fourth exemplary embodiment, the data informing method is determined in accordance with how status information is handled in the center processing apparatus 150.

A logic module 518 for setting and managing an informing method is connected to a storage module 1225 for storing information concerning component modules which refer to status information and to a UI module 522 for checking and setting an informing method.

The storage module 1225 is connected to the logic module 518. The storage module 1225 stores therein, for example, a data informing method table 1300 and an association table 1360 indicating the association between the data size range of information and the number of component modules which refer to information. Then, if a data informing method table 1300 and an association table 1360 are newly created or updated, the center processing apparatus 150 sends the data informing method table 1300 and the association table 1360 to the devices 100 managed by the center processing apparatus 150. Then, the data informing method table 1300 and the association table 1360 are reflected in each device 100. As a result, the data informing method table 1300 and the association table 1360 are stored in a storage module 1220 of the device 100. The storage module 1220 stores therein information concerning component modules which refer to status information.

The logic module 118 is connected to the storage module 1220 and the UI module 122.

The storage module 1220 is connected to the logic module 118.

If the type of status information is a predetermined type, the device information processing module 112 sends this status information to the data storage device 170, which is different from the center processing apparatus 150, depending on the number of center processing component modules that process this status information.

In addition to the operations in the second exemplary embodiment, the following operations are performed in the fourth exemplary embodiment.

In step S4-1, the informing method management module 516 of the center processing apparatus 150 changes the number of center processing component modules that will refer to and process a certain information type.

In step S4-2, the informing method management module 516 instructs the informing method management module 116 of the device 100 to reflect a change made by the informing method management module 516.

In step S4-3, the informing method management module 116 of the device 100 updates a corresponding item of data in the storage module 1220 in response to this instruction.

The device 100 performs processing, for each type of status information, by using a data informing method table and an association table. The data informing method table indicates the number of center processing component modules that refer to status information and perform processing. The association table indicates the association between the data size range of status information and the number of component modules that refer to status information and defines the conditions for setting the default informing method to be “direct informing”. The association table defines that, for example, if the data size of a certain piece of status information is smaller than XXX KB and if the number of center processing component modules that refer to this status information is three or more, the default informing method is set to be “direct sending”.

Upon detecting that data to be sent has been generated, the following operations are performed by using a combination of the data informing method table and the association table.

(1) The number of center processing component modules that refer to a subject piece of status information is extracted.

(2) From the data size of the subject status information and the extracted number of center processing component modules, the default informing method is obtained by referring to the association table. Even if the default informing method is set to be “direct sending”, it may be changed to “storing in data storage device” later, depending on the communication environment.

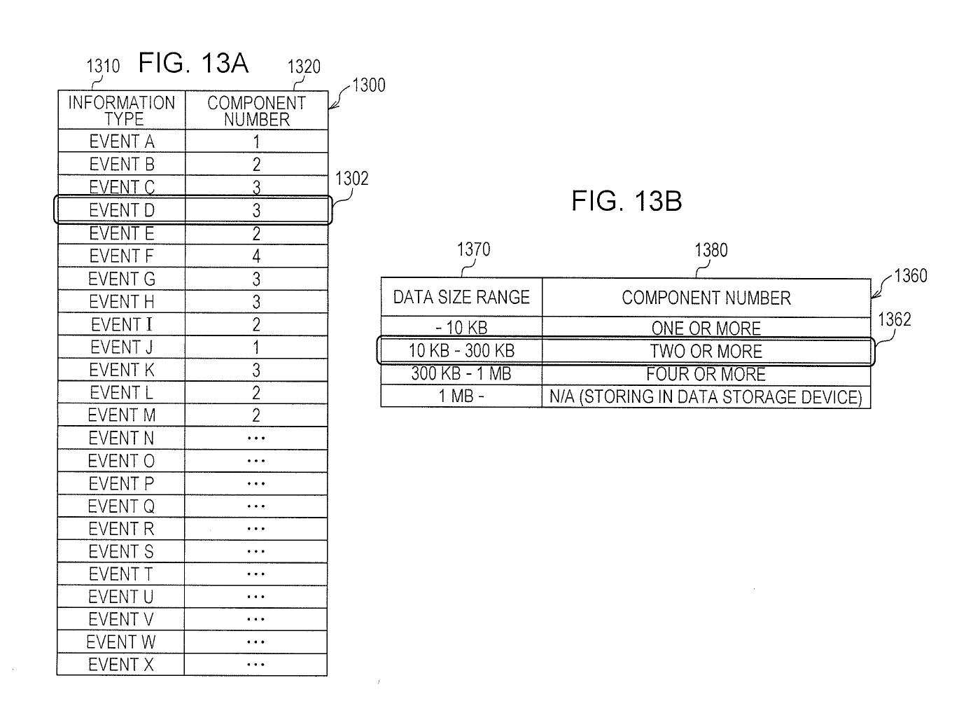

FIGS. 13A and 13B illustrate examples of the data structures of a data informing method table 1300 and an association table 1360 indicating the association between data size range of status information and the number of component modules that refer to status information and defining the conditions for setting the default informing method to be “direct informing”. The data informing method table 1300 shown in FIG. 13A includes an information type field 1310 and a component number field 1320. The information type field 1310 indicates the information type (type of status information). The component number field 1320 indicates the number of center processing component modules that refer to status information.

The association table 1360 shown in FIG. 13B includes a data size range field 1370 and a component number field 1380. The association table 1360 defines that, as more center processing component modules refer to status information, “direct sending” is more likely to be selected. However, if the data size of status information to be sent is equal to or greater than a predetermined threshold, the default informing method is set to be “storing in data storage device”. The data size range field 1370 indicates the data size range of status information to be sent. The component number field 1380 indicates the number of center processing component modules that refer to status information corresponding to each data size range. In the component number field 1380 shown in FIG. 13B, the minimum number of center processing component modules is set as the condition for selecting “direct sending”. Alternatively, the maximum number of center processing component modules or a range (minimum and maximum numbers) of the number of center processing component modules may be set as the condition for selecting “direct sending”. If the conditions set in the data size range field 1370 and the component number field 1380 are satisfied, the default data informing method is set to be “direct sending”.

Upon detecting that data to be sent has been generated, the device information processing module 112 determines the default informing method in the following manner.

(1) The number of center processing component modules that refer to subject status information is extracted by using the data informing method table 1300. For example, in the case of an event D, three center processing component modules refer to this status information.

(2) It is then determined, from the data size of the subject status information and the extracted number of center processing component modules, whether or not the conditions for setting the default informing method to be “direct sending” are satisfied. If the data size of the event D is 100 KB, it is seen from the association table 1360 that the number of center processing component modules is “two or more” for setting the default informing method to be “direct sending”. Since the number of center processing component modules that refer to the event D is three, the default informing method is set to be “direct sending”.

The fourth exemplary embodiment may be combined with, for example, the third exemplary embodiment, and the data informing method may be changed from the default “direct sending” to “storing in data storage device” later, in accordance with the communication environment depending on the time period.

### Fifth Exemplary Embodiment

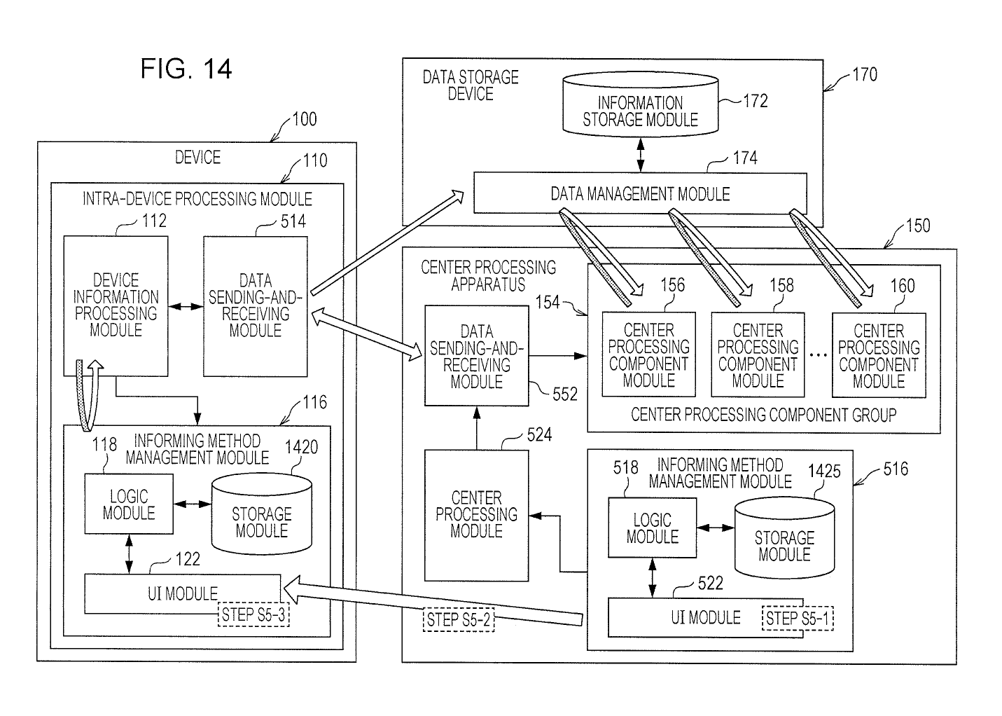

FIG. 14 is a block diagram illustrating conceptual modules of an example of the configuration of a fifth exemplary embodiment. In the fifth exemplary embodiment, the data informing method is determined in accordance with how status information is handled (the level of the immediacy of status information) in the center processing apparatus 150.

The informing method management module 516 of the center processing apparatus 150 includes a logic module 518 for setting and managing an informing method, a storage module 1425 for storing information indicating the level of the immediacy of each piece of information, and a UI module 522 for checking and setting an informing method.

The logic module 518 is connected to the storage module 1425 and the UI module 522.

The storage module 1425 is connected to the logic module 518. The storage module 1425 stores therein, for example, a data informing method table 1500, a time-period transfer speed table 1540, and an assumed communication time table 1570. Then, if a data informing method table 1500, a time-period transfer speed table 1540, and an assumed communication time table 1570 are newly created or updated, the center processing apparatus 150 sends the data informing method table 1500, the time-period transfer speed table 1540, and the assumed communication time table 1570 to the devices 100 managed by the center processing apparatus 150. Then, the data informing method table 1500, the time-period transfer speed table 1540, and the assumed communication time table 1570 are reflected in each device 100. As a result, the data informing method table 1500, the time-period transfer speed table 1540, and the assumed communication time table 1570 are stored in a storage module 1420 of the device 100. The storage module 1420 stores therein information indicating the level of the immediacy of each piece of information.

The logic module 118 is connected to the storage module 1420 and the UI module 122.

The storage module 1420 is connected to the logic module 118.

If the type of status information is a predetermined type, the device information processing module 112 sends this status information to the data storage device 170, which is different from the center processing apparatus 150, depending on the immediacy level demanded by a center processing component module that processes this status information.

In addition to the operations in the second exemplary embodiment, the following operations are performed in the fifth exemplary embodiment.

In step S5-1, the informing method management module 516 of the center processing apparatus 150 changes the level of the immediacy of a center processing component module for a certain information type.

In step S5-2, the informing method management module 516 instructs the informing method management module 116 of the device 100 to reflect a change made by the informing method management module 516.

In step S5-3, the informing method management module 116 of the device 100 updates a corresponding item of data in the storage module 1420 in response to this instruction.

The need to immediately handle status information in the center processing apparatus 150 differs depending on the type of status information. Status information that is necessary to immediately handle is preferentially sent directly to the center processing apparatus 150.

The device 100 performs processing for each type of status information by using a table in which the level of the immediacy of status information demanded by the center processing apparatus 150 is stored. For example, the operator of the device 100 may request the center processing apparatus 150 to process a certain piece of information (status information) that has to be executed immediately by operating an operation unit of the device 100. Since the level of the immediacy of this piece of information is high, it is preferentially sent directly to the center processing apparatus 150.

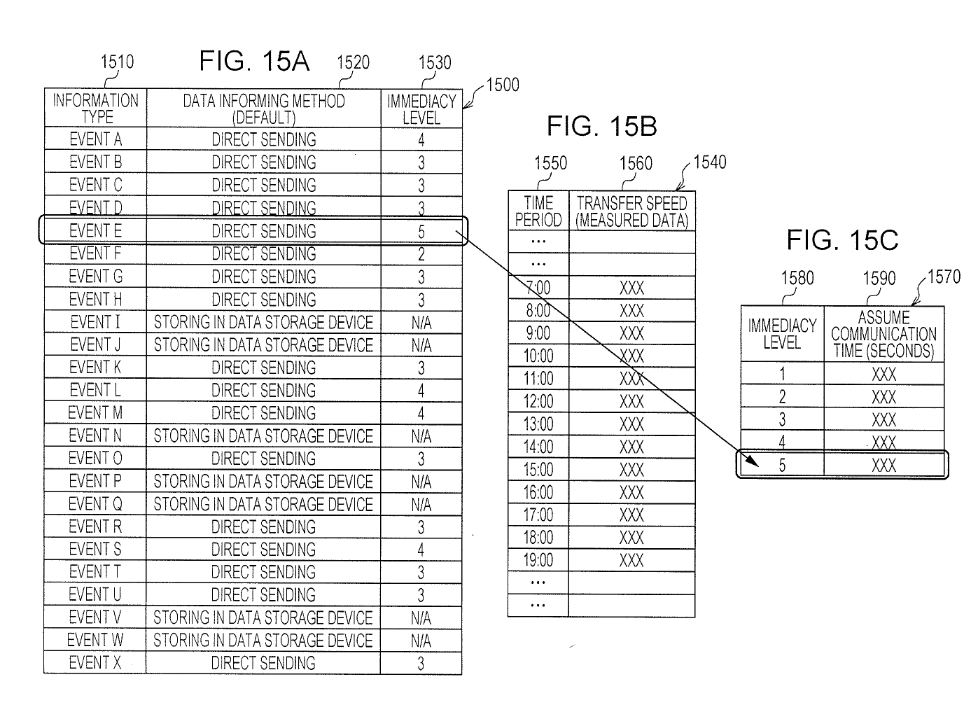

FIGS. 15A, 15B, and 15C illustrate examples of the data structures of the data informing method table 1500, the time-period transfer speed table 1540, and the assumed communication time table 1570, respectively.

The data informing method table 1500 shown in FIG. 15A includes an information type field 1510, a data informing method (default) field 1520, and an immediacy level field 1530. The information type field 1510 indicates the information type (type of status information). The data informing method (default) field 1520 indicates the data informing method (default) for each information type. The immediacy level field 1530 indicates the level of immediacy of each information type. The time-period transfer speed table 1540 shown in FIG. 15B includes a time period field 1550 and a transfer speed (measured data) field 1560. The time period field 1550 indicates the time period. The transfer speed (measured data) field 1560 indicates the transfer speed (measured data) according to the time period. The assumed communication time table 1570 shown in FIG. 15C includes an immediacy level field 1580 and an assumed communication time field 1590. The immediacy level field 1580 indicates the level of immediacy of each information type. The assumed communication time field 1590 indicates the assumed communication time which makes it necessary to switch from “direct sending” to “storing in data storage device” in accordance with the immediacy level. That is, the assumed communication time table 1570 indicates the conditions for switching from “direct sending” to “storing in data storage device” in accordance with the immediacy level.

(1) Upon detecting that data (status information) to be sent has been generated, the time (XX seconds) to directly send the generated data to the center processing apparatus 150 during a current time period is calculated from the time-period transfer speed table 1540.

(2) Then, the immediacy level corresponding to the information type of this data is extracted by using the data informing method table 1500.

(3) By referring to the assumed communication time table 1570, the assumed communication time which makes it necessary to switch from “direct sending” to “storing in data storage device” corresponding to the immediacy level extracted from the data informing method table 1500 is extracted. If the calculated time (XX seconds) is equal to or exceeds the extracted time, the informing method is switched from the default “direct sending” to “storing in data storage device”.

This procedure will be discussed more specifically by taking an event E as an example. The time taken to send the event E is calculated from the data size of the event E and the time period by using the time-period transfer speed table 1540. The data informing method table 1500 shows that the immediacy level of the event E is five. Accordingly, if the calculated time to send the event E is equal to or greater than the value in the assumed communication time field 1590 corresponding to the immediacy level five in the assumed communication time table 1570, “direct sending” is switched to “storing in data storage device”.

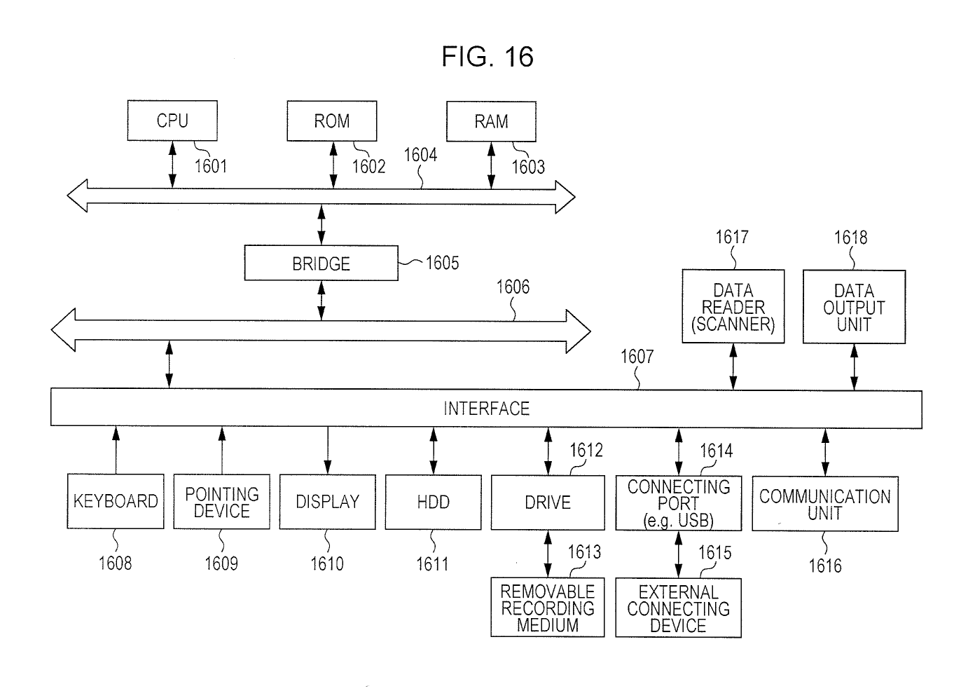

An example of the hardware configuration of the above-described exemplary embodiments (principally, the device 100) will be discussed below with reference to FIG. 16. The configuration shown in FIG. 16 is an example of the hardware configuration of, for example, a PC, which includes a data reader 1617, such as a scanner, and a data output unit 1618, such as a printer.

A CPU 1601 is a controller which executes processing in accordance with a computer program which describes an execution sequence of various modules discussed in the above-described exemplary embodiments, such as the device information processing module 112, the data sending module 114, the informing method management module 116, the logic module 118, the UI module 122, and the data sending-and-receiving module 514.

A read only memory (ROM) 1602 stores therein programs and operation parameters used by the CPU 1601. A RAM 1603 stores therein programs used during the execution of the CPU 1601 and parameters which change appropriately during the execution of the programs. The CPU 1601, the ROM 1602, and the RAM 1603 are connected to one another via a host bus 1604 which is constituted by, for example, a CPU bus.

The host bus 1604 is connected to an external bus 1606, such as a peripheral component interconnect/interface (PCI) bus, via a bridge 1605.

A keyboard 1608 and a pointing device 1609, such as a mouse, are input devices operated by an operator. A display 1610 is, for example, a liquid crystal display or a cathode ray tube (CRT), and displays various items of information as text or image information.

A hard disk drive (HDD) 1611 has a built-in hard disk and drives the hard disk so as to record or play back information or programs executed by the CPU 1601. In the hard disk, status information, for example, is stored. Various other computer programs, such as various data processing programs, are also stored in the hard disk.

A drive 1612 reads data or a program recorded in a removable recording medium 1613, such as a magnetic disk, an optical disc, a magneto-optical disk, or a semiconductor memory, and supplies the read data or program to the RAM 1603 via an interface 1607, the external bus 1606, the bridge 1605, and the host bus 1604. The removable recording medium 1613 is also usable as a data recording region, which is similar to a hard disk.

A connecting port 1614 is a port for connecting the PC to an external connecting device 1615, and has a connecting portion, such as a universal serial bus (USB) port or an IEEE1394 port. The connecting port 1614 is connected to, for example, the CPU 1601, via the interface 1607, the external bus 1606, the bridge 1605, and the host bus 1604. A communication unit 1616 is connected to a connection line and executes data communication processing with an external source. The data reader 1617 is, for example, a scanner, and executes processing for reading documents. The data output unit 1618 is, for example, a printer, and executes processing for outputting document data.

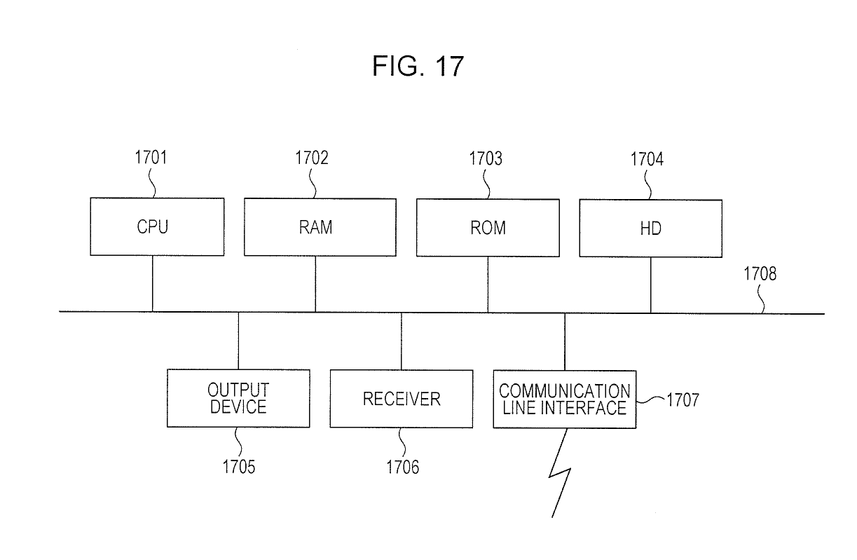

The hardware configuration of a computer that executes programs which serve as the exemplary embodiments (principally, the center processing apparatus 150 and the data storage device 170) is shown in FIG. 17. This computer is a general computer, and more specifically, a computer which serves as a PC or a server. The computer shown in FIG. 17 includes a CPU 1701, which serves as a processor (arithmetic unit), a RAM 1702, a ROM 1703, and an HD 1704, which serve as storage devices, an output device 1705, a receiver 1706, a communication line interface 1707, and a bus 1708. The CPU 1701 executes programs, such as the data receiving module 152, the center processing component group 154 (center processing component modules 156, 158, and 160), the data management module 174, the information method management module 516, the logic module 518, the UI module 522, the data sending-and-receiving module 552, and the center processing module 524. The RAM 1702 stores therein these programs and data. The ROM 1703 stores therein a program for starting this computer. The HD 1704, which is, for example, a hard disk or a solid state drive (SSD), serves as an auxiliary storage device (may be a flash memory). The receiver 1706 receives data on the basis of an operation performed by a user on a keyboard, a mouse, or a touch panel. The output device 1705 is, for example, a CRT or a liquid crystal display. The communication line interface 1707 is, for example, a network interface card, and is used for connecting the computer to a communication network. The above-described elements are connected to one another via the bus 1708 and send and receive data to and from one another. The above-described computer may be connected to another computer configured similarly to this computer via a network.

The above-described exemplary embodiments may be combined (for example, a module of one of the exemplary embodiments may be added to another one of the exemplary embodiments, or may be replaced by a module of another one of the exemplary embodiments).

In the above-described exemplary embodiments, concerning an element implemented by a computer program, a computer program, which is software, is read into a system having the system configuration shown in FIG. 16 or 17, and the above-described exemplary embodiments are implemented in a cooperation of software and hardware resources.

The hardware configurations shown in FIGS. 16 and 17 are only examples, and the exemplary embodiments may be configured in any manner as long as the modules described in the exemplary embodiments are executable. For example, some modules may be configured as dedicated hardware (for example, an application specific integrated circuit (ASIC)), or some modules may be installed in an external system and be connected to the PC via a communication line. Alternatively, a system, such as that shown in FIG. 16 or 17, may be connected to a system, such as that shown in FIG. 16 or 17, via a communication line, and may be operated in cooperation with each other. Additionally, instead of a PC, the modules may be integrated into a home information appliance, a copying machine, a fax machine, a scanner, a printer, or a multifunction device.

The above-described program may be stored in a recording medium and be provided. The program recorded on a recording medium may be provided via a communication medium. In this case, the above-described program may be implemented as a “non-transitory computer readable medium storing the program therein” in an exemplary embodiment of the invention.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray disc (registered), a magneto-optical disk (MO), a flexible disk (FD), magnetic tape, a hard disk, a ROM, an electrically erasable programmable read only memory (EEPROM) (registered), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be part of another program, or may be recorded, together with another program, on a recording medium. The program may be divided and recorded on plural recording media. Further, the program may be recorded in any form, for example, it may be compressed or encrypted, as long as it can be reconstructed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first sender that sends, if a type of status information indicating a status of a device is a predetermined type, the status information to an information storage apparatus, which is different from a center apparatus that manages the device; and
a second sender that sends information indicating that the status information has been sent to the information storage apparatus to the center apparatus.

2. The information processing apparatus according to claim 1, wherein:
the center apparatus includes at least one information processor, and the at least one information processor processes the status information; and
the predetermined type is a type which is set in accordance with a size of the status information or a level of the need for each of the at least one information processor to obtain the status information.

3. The information processing apparatus according to claim 1, further comprising:
a detector that detects a capability to send the status information to the center apparatus;
a switching unit that switches a destination to which the status information will be sent from the center apparatus to the information storage apparatus if the capability detected by the detector matches a certain condition; and
a second switching unit that switches a destination to which second status information having a size equal to or greater than a size of the status information will be sent from the center apparatus to the information storage apparatus.

4. The information processing apparatus according to claim 2, further comprising:
a detector that detects a capability to send the status information to the center apparatus;
a switching unit that switches a destination to which the status information will be sent from the center apparatus to the information storage apparatus if the capability detected by the detector matches a certain condition; and
a second switching unit that switches a destination to which second status information having a size equal to or greater than the size of the status information will be sent from the center apparatus to the information storage apparatus.

5. The information processing apparatus according to claim 3, wherein, if the capability detected by the detector matches a condition which is set in accordance with a time period, the switching unit switches a destination to which the status information will be sent during the time period from the center apparatus to the information storage apparatus.

6. The information processing apparatus according to claim 4, wherein, if the capability detected by the detector matches a condition which is set in accordance with a time period, the switching unit switches a destination to which the status information will be sent during the time period from the center apparatus to the information storage apparatus.

7. The information processing apparatus according to claim 1, wherein:
the center apparatus includes at least one information processor, and the at least one information processor processes the status information; and
if the type of status information is a predetermined type, the first sender sends the status information to an information storage apparatus, which is different from the center apparatus, depending on the number of information processors that process the status information.

8. The information processing apparatus according to claim 1, wherein:
the center apparatus includes at least one information processor, and the at least one information processor processes the status information; and
if the type of status information is a predetermined type, the first sender sends the status information to an information storage apparatus, which is different from the center apparatus, depending on a level of immediacy demanded by the at least one information processor that processes the status information.

9. An information processing system comprising:
an information processing apparatus; and
a center apparatus that manages a device,
the information processing apparatus including
a first sender that sends, if a type of status information indicating a status of the device is a predetermined type, the status information to an information storage apparatus, which is different from the center apparatus, and
a second sender that sends information indicating that the status information has been sent to the information storage apparatus to the center apparatus,
the center apparatus including
at least one information processor, the at least one information processor processing the status information, and
a sender that sends the information processing apparatus an instruction to set, as the predetermined type, a type which is set in accordance with a size of the status information or a level of the need for each of the at least one information processor to obtain the status information,
wherein the first sender of the information processing apparatus sets the type as the predetermined type and performs processing.

10. An information processing method comprising:
sending, if a type of status information indicating a status of a device is a predetermined type, the status information to an information storage apparatus, which is different from a center apparatus that manages the device; and
sending information indicating that the status information has been sent to the information storage apparatus to the center apparatus.

11. A non-transitory computer readable medium storing a program causing a computer to execute a process, the process comprising:
sending, if a type of status information indicating a status of a device is a predetermined type, the status information to an information storage apparatus, which is different from a center apparatus that manages the device; and
sending information indicating that the status information has been sent to the information storage apparatus to the center apparatus.
